(19) United States
(12) Patent Application Publication
(10) Pub. No.: US 2012/0037108 A1
(43) Pub. Date: Feb. 16, 2012

(54) Laser Spark Plug

(76) Inventors: Werner Herden, Gerlingen (DE); Martin Weinrotter, Stuttgart-Botnang (DE); Pascal Woerner, Stuttgart (DE); Juergen Raimann, Weil Der Stadt (DE); Joerg Engelhardt, Ditzingen (Hirschlanden) (DE)

(21) Appl. No.: 13/201,948

(22) PCT Filed: Feb. 1, 2010
(86) PCT No.: PCT/EP10/51158

§ 371 Date: Oct. 27, 2011

(30) Foreign Application Priority Data
Feb. 18, 2009 (DE) 10 2009 000 958.2

(51) Int. Cl. F02P 23/04

(52) U.S. Cl. 123/143 B

(57) ABSTRACT

A laser spark plug, in particular for an internal combustion engine of a motor vehicle is described. A fixing arrangement is provided in an end region of the laser spark plug facing the combustion chamber. The fixing arrangement allows an optical component to be detachably fixed to the laser spark plug.

### FIELD OF THE INVENTION

The present invention relates to a laser spark plug, in particular for an internal combustion engine of a motor vehicle.

### BACKGROUND INFORMATION

Laser-based ignition systems for internal combustion engines are generally available. Laser spark plugs, which have an integrated laser device and which are able to radiate the generated laser radiation into a combustion chamber of the internal combustion engine, are used, for example. In the conventional laser spark plugs, a focusing lens which is necessary for the beam shaping of the laser radiation and a combustion chamber window which is provided for sealing the interior of the laser device with respect to a combustion chamber are permanently integrated, together with the laser device, into a housing of the laser spark plug.

When the combustion chamber window becomes soiled or the combustion chamber window or the beam-shaping lens is damaged, the entire laser spark plug must always be replaced, although the laser device is still functional.

### SUMMARY

An object of the present invention is to improve a laser spark plug in such a way that increased flexibility is provided, and in particular the situation is avoided that when the combustion chamber window becomes soiled or worn, the entire laser spark plug must be replaced and disposed of. In accordance with an example embodiment of the present invention, this object may be achieved by providing a fixing arrangement in an end region of the laser spark plug facing the combustion chamber, the fixing arrangement allowing an optical component to be detachably fixed to the laser spark plug.

With the aid of the example fixing arrangement according to the present invention, the option is advantageously provided for situating one or multiple optical components in the end region of the laser spark plug facing the combustion chamber, in particular in the beam path of the laser radiation generated by the laser spark plug. As a result of the detachable fixing, such components may also be provided after completion of a manufacturing process for the laser spark plug, or may be replaced, in particular during routine maintenance of an internal combustion engine containing the laser spark plug.

The fixing arrangement may particularly preferably have a screw thread and/or a press fit and/or a snap-on connection.

According to another advantageous specific embodiment of the present invention, a sealing arrangement is provided in the region of the fixing arrangement, thus allowing a replaceable optical component to be mounted on the laser spark plug in such a way that an existing interspace between the replaceable optical component and optionally the permanently installed optical components or the laser device itself may be sealed with respect to the combustion chamber of the internal combustion engine.

The optical component may particularly preferably be designed as a combustion chamber window. This means that the laser spark plug according to the present invention may be provided with a replaceable combustion chamber window, so that simple replacement with a new combustion chamber window is possible when the replaceable combustion chamber window becomes worn. In particular, as a result of the targeted replacement of the combustion chamber window, the rest of the laser spark plug may advantageously continue to be used. In addition to the replaceable combustion chamber window according to the present invention, the example laser spark plug according to the present invention may have a permanently installed additional combustion chamber window which is situated between the laser device and the replaceable combustion chamber window.

Alternatively, the laser spark plug according to the present invention may have only a permanently installed beam-shaping lens, for example a focusing lens, for focusing the laser radiation on an ignition point in the combustion chamber, while the combustion chamber window is formed by the replaceable optical component according to the present invention. In this case, the replaceable combustion chamber window should be replaced under clean room or comparable conditions, so that the focusing lens or laser device, which is not protected by a permanently installed primary combustion chamber window, is not soiled during the replacement.

The optical component which is fixable to the laser spark plug with the aid of the example fixing arrangement according to the present invention may advantageously also be designed as a focusing lens, the optical component cooperating with a focusing lens which is already permanently installed.

It is also possible to use the fixing arrangement according to the present invention to provide multiple optical components in the beam path of the laser spark plug, or to connect same to the laser spark plug.

When the fixing arrangement according to the present invention has a screw thread, for example, the replaceable optical component according to the present invention may be fixed to the laser spark plug with the aid of a threaded ring, the threaded ring cooperating with the fixing arrangement of the laser spark plug.

According to another variant of the present invention, the optical component may have a support which is designed to cooperate with the fixing arrangement of the laser spark plug. In this case the optical component may, for example, be integrated into the support, so that together with the support it is replaceable as a structural unit and may be screwed in together with the laser spark plug.

The fixing arrangement of the laser spark plug according to the present invention may also advantageously be used to mount a prechamber module, for example, in addition to an optical component, in the end region of the laser spark plug facing the combustion chamber. The prechamber module on the one hand is used for achieving the functionality of a prechamber, and on the other hand may advantageously brace the replaceable optical component directly against the laser spark plug. It is also possible to integrate an optical component, such as a combustion chamber window, into a prechamber module which is mounted on the laser spark plug via the connecting arrangement according to the present invention.

Further advantages, features, and particulars result from the following description, in which various exemplary embodiments of the present invention are illustrated with reference to the figures. Features mentioned in the description may in each case be used in accordance with the present invention, alone or in any given combination.

### BRIEF DESCRIPTION OF THE DRAWINGS

FIG. 1 shows a partial cross section of a first specific embodiment of a laser spark plug according to the present invention.

FIG. 2 shows one specific embodiment of a support according to the present invention for an optical component.

FIG. 3 shows another specific embodiment of a laser spark plug according to the present invention.

### DETAILED DESCRIPTION OF EXAMPLE EMBODIMENTS

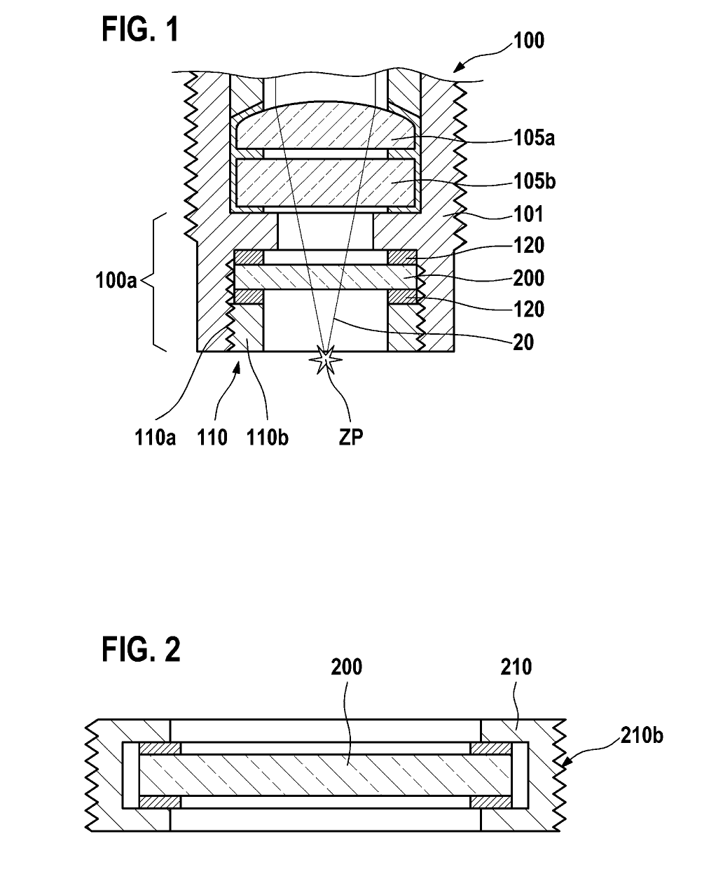

FIG. 1 shows a partial cross section of an example laser spark plug 100 according to the present invention which may be used, for example, in an internal combustion engine of a motor vehicle or also in large stationary gas engines for igniting a combustible mixture.

A laser device, not illustrated, is integrated into a housing 101 of laser spark plug 100, the laser device generating high-energy laser pulses 20 in a conventional manner, for example with the aid of a passive Q switch. A focusing lens 105a which focuses laser radiation 20 through combustion chamber window 105b, likewise situated in housing 101, on an ignition point ZP is situated in the optical path downstream from the laser device.

Optical components 105a, 105b, like the laser device, are permanently mounted in housing 101 of laser spark plug 100, and therefore are usually not individually replaceable.

According to an example embodiment of the present invention, laser spark plug 100 has a fixing arrangement 110, which are situated in an end region 100a of the laser spark plug facing the combustion chamber, and allow an optical component 200 to be detachably fixed to laser spark plug 100.

The option is advantageously provided for situating one or multiple easily replaceable optical components in the beam path of laser spark plug 100.

In the present case, optical component 200 is designed as an additional combustion chamber window, for example. During operation of laser spark plug 100 in an internal combustion engine, this additional combustion chamber window. 200, also referred to as a sacrificial window, experiences wear due to thermal stress and being acted on by combustion products and the like, to which combustion chamber window 105b, which is permanently integrated into laser spark plug 100, is exposed in conventional laser spark plugs.

As soon as sacrificial window 200 has reached a predefinable wear threshold or operating period, it may be easily replaced with a new sacrificial window 200 on account of fixing arrangement 110 according to the present invention. In particular, for this purpose entire laser spark plug 100 does not have to be replaced and disposed of. Rather, it is possible to only provide only a new sacrificial window 200, which from that point on is operated together with original laser spark plug 100. Laser spark plug 100 may advantageously be reused as a result.

In addition to the correspondingly lower maintenance costs for replacing sacrificial window 200, the effort required for disposing of functional laser devices, which is necessary in the conventional systems, is avoided.

In the exemplary embodiment illustrated in FIG. 1, fixing arrangement 110 according to the present invention is provided by a screw thread, end region 100a of laser spark plug 100 which faces the combustion chamber having an internal thread 110a which cooperates with a screw ring 110b which has a corresponding external thread. For replacement of sacrificial window 200, after inserting a new sacrificial window 200 into end region 100a, screw ring 110b is screwed into the screw thread of fixing arrangement 110, and is thus used to press new sacrificial window 200 against housing 101 of laser spark plug 100. Sealing means 120 provided in the region of fixing means 110 are used to protect the inner space, formed between permanently installed combustion chamber window 105b and sacrificial window 200, from the penetration of dirt particles.

As an alternative to the functionality solely as a sacrificial window, optical component 200 may be designed as a focusing lens, and may cooperate with focusing lens 105a which is permanently installed in laser spark plug 100 in order to focus laser radiation 20.

It is also possible, using the example fixing arrangement 110 according to the present invention, to provide multiple optical components 200 in the beam path of laser spark plug 100.

FIG. 2 shows a support 210 according to an example embodiment of the present invention for an optical component 200 which is provided for mounting in end region 100a of laser spark plug 100. Optical support 210 is made of steel, for example, and together with optical component 200 which is integrated therein forms a structural unit which may be replaced particularly easily. In the present case, support 210 has an external thread 210b which, similarly to the external thread of screw ring 110b from FIG. 1, is able to cooperate with internal thread 110a of fixing arrangement 110 in order to screw support 210 into laser spark plug 100.

In addition to the screw thread, a press fit and/or a snap-on connection or the like may be provided in order to detachably fix the at least one optical component 200 to laser spark plug 100.

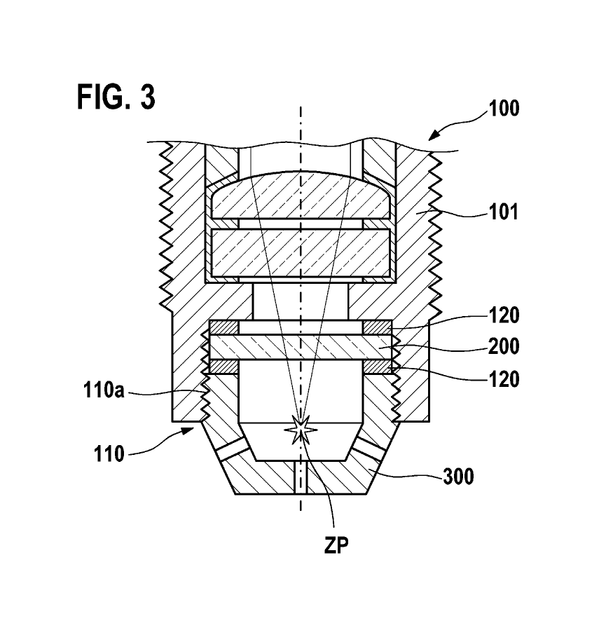

FIG. 3 shows another specific embodiment of laser spark plug 100 according to the present invention, in which fixing arrangement 110 according to the present invention is used to connect a prechamber module 300 to laser spark plug 100. In the present case, prechamber module 300 has an external thread, not described in greater detail, via which, similarly to screw ring 110b from FIG. 1, the prechamber module may be screwed into internal thread 110a of fixing arrangement 110.

Similarly to screw ring 110b from FIG. 1, prechamber module 300 is used for fixing optical component 200 in end region 100a of the laser spark plug facing the combustion chamber (FIG. 1).

Thus, prechamber module 300 according to the present invention allows on the one hand the detachable fixing of optical component 200, and on the other hand, implementation of a prechamber for the laser ignition by laser spark plug 100.

It is also possible to integrate an optical component 200, such as a combustion chamber window, into prechamber module 300. In this case as well, optical component 200 together with prechamber module 300 is easily replaced. Optical component 200 may, for example, be fixed in prechamber module 300 via a screw ring (not shown) which cooperates with an internal thread of prechamber module 300. As an alternative to a screwable mounting ring, optical component 200 may be fixed in prechamber module 300 via a simple mounting ring which is joined to prechamber module 300 by laser welding, for example. When the material is suitably selected, optical component 200 may also be soldered directly to prechamber module 300.

1-7. (canceled)

8. A laser spark plug for an internal combustion engine of a motor vehicle, the laser spark plug having a fixing arrangement provided in an end region of the laser spark plug facing a combustion chamber, the fixing arrangement allowing an optical component to be detachably fixed to the laser spark plug.

9. The laser spark plug as recited in claim 8, wherein the fixing arrangement includes at least one of a screw thread, a press fit, and a snap-on connection.

10. The laser spark plug as recited in claim 8, wherein a sealing arrangement is provided in a region of the fixing arrangement.

11. The laser spark plug as recited in claim 8, further comprising:
at least one optical component detachably connectable to the laser spark plug via the fixing arrangement.

12. The laser spark plug as recited in claim 11, wherein the optical component is at least one of a combustion chamber window and a focusing lens.

13. The laser spark plug as recited in one of claim 12, wherein the optical component has a support which is configured to cooperate with the fixing arrangement of the laser spark plug.

14. The laser spark plug as recited in claim 8, further comprising:
a prechamber module connectable in a detachable manner to the laser spark plug.
